(19) United States
(12) Patent Application Publication
(10) Pub. No.: US 2022/0351111 A1
(43) Pub. Date: Nov. 3, 2022

(54) SYSTEMS AND METHODS FOR PREDICTIVE RESERVOIR DEVELOPMENT

(71) Applicant: ConocoPhillips Company, Houston, TX (US)

(72) Inventors: Vishal Bang, Houston, TX (US); Qing Tao, Houston, TX (US); Greg S. Lemons, Houston, TX (US); Vinit N. Rajani, Houston, TX (US)

(21) Appl. No.: 17/734,856

(22) Filed: May 2, 2022

Related U.S. Application Data
(60) Provisional application No. 63/182,101, filed on Apr. 30, 2021.

(51) Int. Cl. G06Q 10/06

(52) U.S. Cl. CPC G06Q 10/06375

(57) ABSTRACT

Implementations described and claimed herein provide systems and methods for predictive reservoir development. In one implementation, asset data is received for a particular asset, with the particular asset corresponding to a particular reservoir. A model of the particular asset is generated based on the asset data. Asset intelligence is generated for the particular asset at an asset life cycle stage based on the model, and development of the particular reservoir is optimized using the asset intelligence.

### CROSS-REFERENCE TO RELATED APPLICATIONS

The present application claims priority to U.S. Provisional Application No. 63/182,101, entitled “SYSTEMS AND METHODS FOR PREDICTIVE RESERVOIR DEVELOPMENT” and filed on Apr. 30, 2021, which is specifically incorporated by reference in its entirety herein.

### FIELD

Aspects of the present disclosure relate generally to systems and methods for developing resources from reservoirs, including unconventional reservoirs, and more particularly to unconventional resource development using physics assisted machine learning for predictive analytics beyond data limitations of a training dataset.

### BACKGROUND

Unconventional reservoirs, such as shale gas reservoirs, shale oil reservoirs, and/or the like, are generally complex both in terms of geology and development. More particularly, shales are highly heterogeneous due to nanoscale pore size and highly variable structures. Characterizing shale geology in terms of permeability and natural fractures remains a pervasive challenge. Exacerbating these challenges, performance of an unconventional well is strongly driven by development approaches in drilling, well placement, and completion over the life cycle of reservoir development, and the technology to reliably characterize and model physical properties of a reservoir is insufficient. The insufficiencies of such conventional technologies are especially apparent in the absence of detailed geology, stress field characterization, natural and hydraulic fracture delineation. The challenges only increase when modeling multiple wells with interference or communication between fractures. Overall, different data analytics techniques are limited in their ability to generate predictions for a reservoir beyond the confines of the data and detached from the life cycle stage of the reservoir. It is with these observations in mind, among others, that various aspects of the present disclosure were conceived and developed.

### SUMMARY

Implementations described and claimed herein address the foregoing problems by providing systems and methods for predictive reservoir development. In one implementation, asset data is received for a particular asset, with the particular asset corresponding to a particular reservoir. A model of the particular asset is generated based on the asset data. Asset intelligence is generated for the particular asset at an asset life cycle stage based on the model, and development of the particular reservoir is optimized using the asset intelligence.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example asset development system.

FIG. 2 is a block diagram illustrating example predictive reservoir development for a particular reservoir.

FIG. 3 shows an example network environment that may implement various systems and methods discussed herein.

FIG. 4 depicts an example application of a model for a particular reservoir to predict budget at completion performance across equalizing feature acreage.

FIG. 5 illustrates example operations for predictive reservoir development.

FIG. 6 depicts an example electronic device including operational units arranged to perform various operations of the presently disclosed technology.

FIG. 7 shows an example computing system that may implement various systems and methods discussed herein.

### DETAILED DESCRIPTION

Aspects of the present disclosure involve systems and methods for predictive reservoir development. Generally, development of an unconventional reservoir is driven by a variety of factors including geology, petrophysics, rock properties, fluid properties, and/or the like. The presently disclosed technology utilizes a machine learning framework in connection with reservoir modeling based physics using these factors to provide predictions regarding reservoir performance. Various types of assets may be analyzed using the presently disclosed technology. For example, in the context of exploration prospects, the systems and methods described herein facilitate evaluation of new play(s). Additionally, the presently disclosed technology provides timely analysis of well spacing and completions by shortening the learning curve for new assets and guides development optimization for mature assets. Overall, the systems and methods optimize reservoir development by providing predictions extrapolated beyond data limits for critical development decisions throughout the life of an asset. Other advantages will be apparent from the present disclosure.

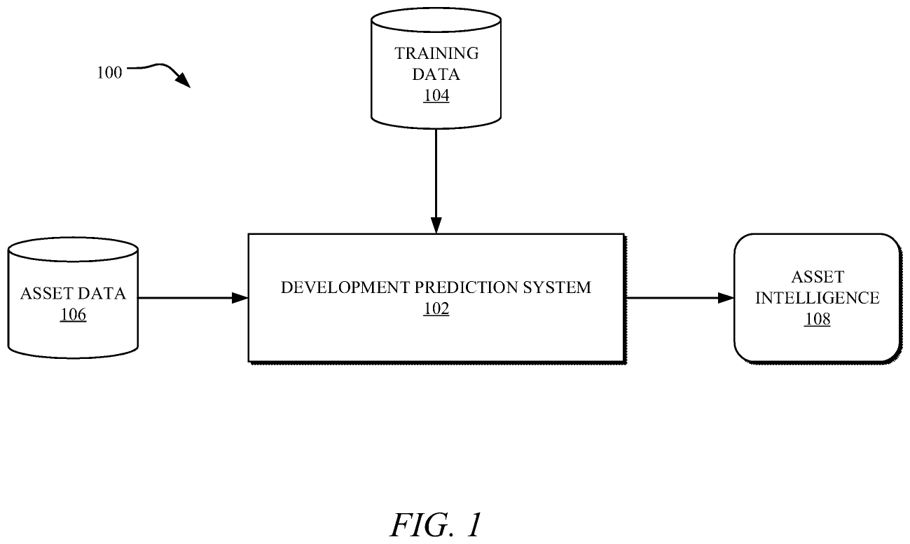

To begin a detailed discussion of an example asset development system 100, reference is made to FIG. 1. In one implementation, the asset development system 100 includes a development prediction system 102 that generates asset intelligence 108 using asset data 106 for one or more assets through reservoir simulation with machine learning models, such as random forest, linear regression, boosted trees, non-linear regression, support vector machine, neural networks, and/or the like. The machine learning framework of the development prediction system 102 is trained using training data 104, which may include one or more training sets of well data, mechanistic simulation cases representing asset properties, and/or the like.

In one implementation, the development prediction system 102 combines predictions from multiple machine learning algorithms to increase prediction accuracy through ensemble learning. For example, random forest is a supervised learning algorithm using ensemble learning that constructs a plurality of decision trees based on the training data 104 and outputs a regression of the individual decision trees into a single model outperforming the prediction of any individual decision tree. Similarly, in another implementation, the development prediction system 102 uses a gradient boosting model, which provides predictions in the form of an ensemble of weak prediction models, such as decision trees, and builds the prediction in a stage-wise fashion. More particularly, gradient boosting involves an additive model to add weak learners to minimize a loss function.

Linear regression models may be used by the development prediction system 102 in another implementation to make predictions outside of the training data 104 since a random forest and gradient boosting model interpolate rather than extrapolate data. Simple or multiple linear regression is a linear machine learning model that assumes a linear relationship between input variable(s) and a single output variable, such that the asset intelligence 108 can be calculated from a linear combination of the input variable(s) of the asset training data 106. In this implementation, the linear regression equation of the development prediction system 102 may be trained using various techniques, such as ordinary least squares.

To extrapolate and/or interpolate data outside of linear relationships, the development prediction system 102 may use a non-linear regression model including linear coefficients with non-linear variables to describe non-linear relationships in the asset date 106. The development prediction system 102 generates the asset intelligence 108 by modeling a set of one or more dependent variables as a function of a combination of non-linear parameters and one or more independent variables.

Support vector machines may be used by the development prediction system 102 to generate the asset intelligence 108. The support vector machine algorithm involves supervised learning models to provide increased accuracy in classification and regression with less computational burden. Generally, the support vector machine algorithm provides a hyperplane that is a decision boundary in an N-dimensional space that classifies data points. The dimension corresponds to a number of input features. The hyperplane with a maximum margin corresponding to a maximum distance between data points of different classes is chosen to classify data points with increased confidence. Support vectors are data points impacting position and orientation of the hyperplane and are used to maximize the margin of the classifier.

The development prediction system 102 may leverage a neural network trained using the asset training data 106 to generate the asset intelligence 108 from the asset data 104. The learned neural network of the development prediction system 102 utilizes a network of functions to translate the asset data 104 as inputs into another form of output as the asset intelligence 108.

Regardless of the machine learning model utilized by the development prediction system 102, the training data 104 for training the development prediction system 102 may include well data and mechanistic simulation cases representing assets at various stages of asset life cycle. The development prediction system 102 may be regularly trained with new data. The development prediction system 102 utilizes key variables, including a target variable and a plurality of dependent variables, to generate the asset intelligence 108 from the asset data 106. For example, the target variable may be 12 month cumulative in barrels of oil equivalent (BOE) per foot (boe/ft), and the dependent variables may include pressure (pr), estimated ultimate recovery (EUR) in millions of BOE, Young's modulus (YM), bulk volume hydrocarbon (BVH), Proppant per foot (prop/ft), spacing, lateral length, and/or the like. The asset intelligence 108 may be generated based on the target variable to define optimal asset strategy for an asset at any stage of asset life cycle for the asset. Stages of the asset life cycle may include, without limitation, exploration and appraisal, development, production, and abandonment.

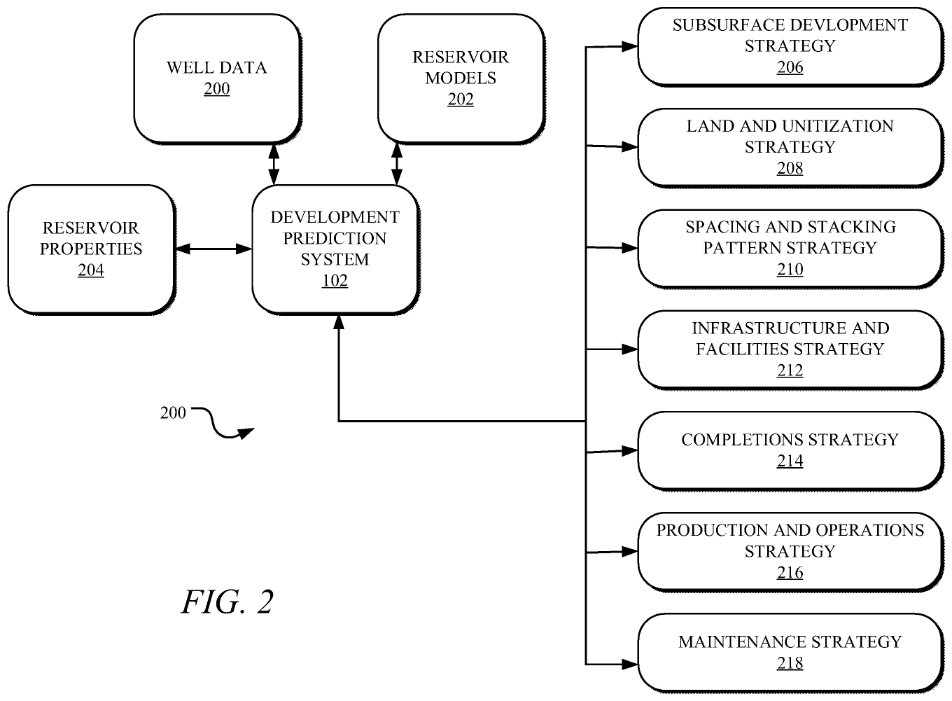

Referring to FIG. 2, a diagram 200 illustrates example predictive reservoir development for a particular asset, such as a particular reservoir, using the asset development system 100. In one implementation, the asset development system 100 obtains well data 200, reservoir models 202, and reservoir properties 204, which may be incorporated into the training data 104 and/or the asset data 106. For example, the training data 104 may include the well data 200 corresponding to at least one asset and the reservoir models 202 including mechanistic simulation cases representing the at least one asset.

In one implementation, the development prediction system 102 obtains the physics of one or more assets through simulation models using the well data 200, reservoir models 202, the reservoir properties, and/or the like. The reservoir properties 204 include a range of geological properties for one or more assets from which a single well model, including geology, range of completions, and/or the like, may be generated. Cases may be selected from the single well model to incorporate into the training data 104 for training the machine learning model of the development prediction system 102. In one example, the reservoir properties 204 include porosity and water saturation, as well as other geological properties of the asset. The reservoir model 202 including a single well model wide including the geology and range of completions may include a plot of the 12 month cum boe/ft verses BVH. There may be a wide range in production for a given BVH, primarily driven by uncertainty in a fracture geometry, with a next phase including geomechanics. Using the trained machine learning model, the development prediction system 102 provides predictions outside these dataset limits to generate the asset intelligence 108 for the particular asset. For example, a cumulative probability distribution may be captured including the 10-90% range for 12 month BOE/ft.

As described herein, the development prediction system 102 provides predictive analytics in the form of the asset intelligence 108 beyond the confines of the asset data 106 by coupling physics with the machine learning model of the development prediction system 102. Stated differently, the development prediction system 102 includes a predictive model built on integrated data from various assets, including plays that failed. The development prediction system 102 optimizes future development strategy for one or more assets through the asset intelligence 108, including through an application of the asset intelligence 108 to assets, such as new plays and areas to frame uncertainty and shorten the learning curve.

The asset intelligence 108 generated by the development prediction system 102 includes optimal asset strategy for an asset at any stage of the asset life cycle for the asset. Stages of the asset life cycle may include, without limitation, exploration and appraisal, development, production, and abandonment. The asset intelligence 108 may include, without limitation, subsurface development strategy 206, land and unitization strategy 208, spacing and stacking pattern strategy 210, infrastructure and facilities strategy 212, completions strategy 214, production and operations strategy 216, maintenance strategy 218, and/or the like. For example, in the context of exploration prospects, the development prediction system 102 may facilitate evaluation of new play(s). Additionally, the development prediction system 102 may provide timely analysis of well spacing and completions by shortening the learning curve for new assets and guide development optimization for mature assets. An early stage of the asset life cycle may correspond to exploration and appraisal and early development of an asset. A middle stage of the asset life cycle may correspond to development and production of an asset, and a late stage of the asset life cycle may correspond to late production and abandonment of an asset.

In one implementation, at the early stage of the asset life cycle for a particular asset, the asset intelligence 108 may be used to determine commerciality early to reach a decision point for the asset. During the early stage, the asset intelligence 108 shortens the learning curve. For example, the spacing and stacking pattern strategy 210, the completions strategy 214, and the production and operations strategy 216 may be used to inform spacing and stacking decisions, completions, and operations decisions. As such, the asset intelligence 108 addresses a range of uncertainties associated with the early stage of the asset life cycle and integrates geology with development decisions. The asset intelligence 108 frames uncertainty in outcome, including in relation to fluid type and well deliverability to design infrastructure.

With respect to the middle cycle of the asset life cycle, the asset intelligence 108 optimizes economics by moving to optimum development faster through informed strategies (e.g., using one or more of the strategies 206-218). The development prediction system 102 captures all changes in spacing and stacking and completions and operations as the asset data 104. The asset intelligence 108 provides insight into which of these changes are working and which are not working, as well as optimized asset strategy based on the changes. The asset intelligence 108 may be used to determine if and when to incorporate changes. Similarly, the asset intelligence 108 may be used to determine how to incorporate geology into design completion and determine the economic well life of an asset. Generally, the asset intelligence 108 may include an asset development strategy considering scheduling, spacing, stacking, project size, frac hits, production impact, geology, production decisions, facilities, completions, performance analysis, MVA, and/or the like.

The development prediction system 102 may be used with a new play, early in development, and apply to pilot holes and single wells. Stated differently, the asset intelligence 108 may be used at an early development stage of a particular asset, including single wells and smaller completions.

In one implementation, the development prediction system 102 optimizes development strategy for undrilled parts of a particular reservoir with the asset intelligence 108. The development strategy may be based on one or more of the strategies 206-218. The development strategy may include well spacing, well orientation and placement, well lengths, completions, central infrastructure and associated production risk with future development, among other strategies. The trained model of the development prediction system 102 may predict a target variable from the key variables. For example, the target variable may be n month cum production or other economic metric. However, other target variables are contemplated. The development prediction system 102 predicts the target variable based on subsurface, development, completion, production parameters, and/or the like.

Variable parameters may include subsurface parameters, development and completion parameters, operation and facilities parameters, performance parameters, and/or the like. The subsurface parameters may include, without limitation, BVH, thickness, fractures, faults, FEV features, frac hits, landing targets, and/or the like. The development and completion parameters may include, without limitation, wellbore geometry, orientation, completion size, zipper, completion design, such as ppg, number per cluster, and/or the like. The operation and facilities parameters may include, without limitation, operating strategy (e.g., PM, APM, OP, etc.), facility network, artificial lift, workover, remedials, water management, and/or the like. The performance parameters may include, without limitation, impacted, non-impacted, confined, unconfined, degradation, well life, event size, and/or the like.

The development prediction system 102 provides the ability to predict beyond the input parameter ranges of the dependent variables, as well as to optimize model parameters, including the dependent variables, to maximize desired output, including the target variable. For example, the model of the development prediction system 102 may be applied to a relatively undrilled area where some of the input variables are fixed, such as geologic properties or other reservoir properties 204, and a combination of other variables are found that would maximize the output. Based on the asset intelligence 108 generated in this manner, spatial placement of wells based on the optimized parameters, an optimized drill schedule with the associated infrastructure, probability based prediction of frac hits impact on parent well performance, and/or the like may be determined.

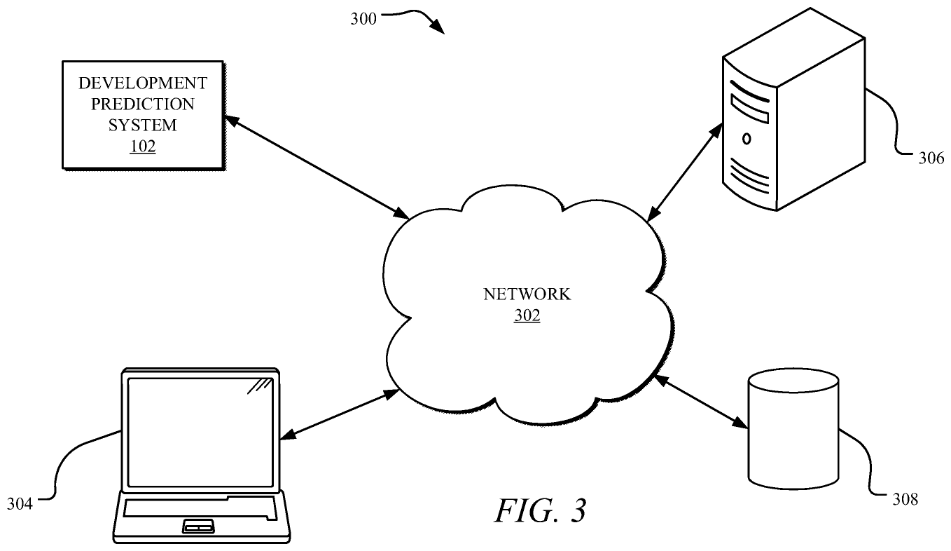

FIG. 3 illustrates an example network environment 300 for implementing the various systems and methods, as described herein. As depicted in FIG. 3, a network 302 is used by one or more computing or data storage devices for implementing the systems and methods for developing resources from one or more reservoirs using the development prediction system 102. In one implementation, various components of the asset development system 100, one or more user devices 304, one or more databases 308, and/or other network components or computing devices described herein are communicatively connected to the network 302. Examples of the user devices 304 include a terminal, personal computer, a smart-phone, a tablet, a mobile computer, a workstation, and/or the like.

A server 306 hosts the system. In one implementation, the server 306 also hosts a website or an application that users may visit to access the system 100, including the development prediction system 102. The server 306 may be one single server, a plurality of servers with each such server being a physical server or a virtual machine, or a collection of both physical servers and virtual machines. In another implementation, a cloud hosts one or more components of the system. The development prediction system 102, the user devices 304, the server 306, and other resources connected to the network 302 may access one or more additional servers for access to one or more websites, applications, web services interfaces, etc. that are used for resource development, including asset development prediction. In one implementation, the server 306 also hosts a search engine that the system uses for accessing and modifying information, including without limitation, the asset data 106, the training data 104, the asset intelligence 108, and/or other data.

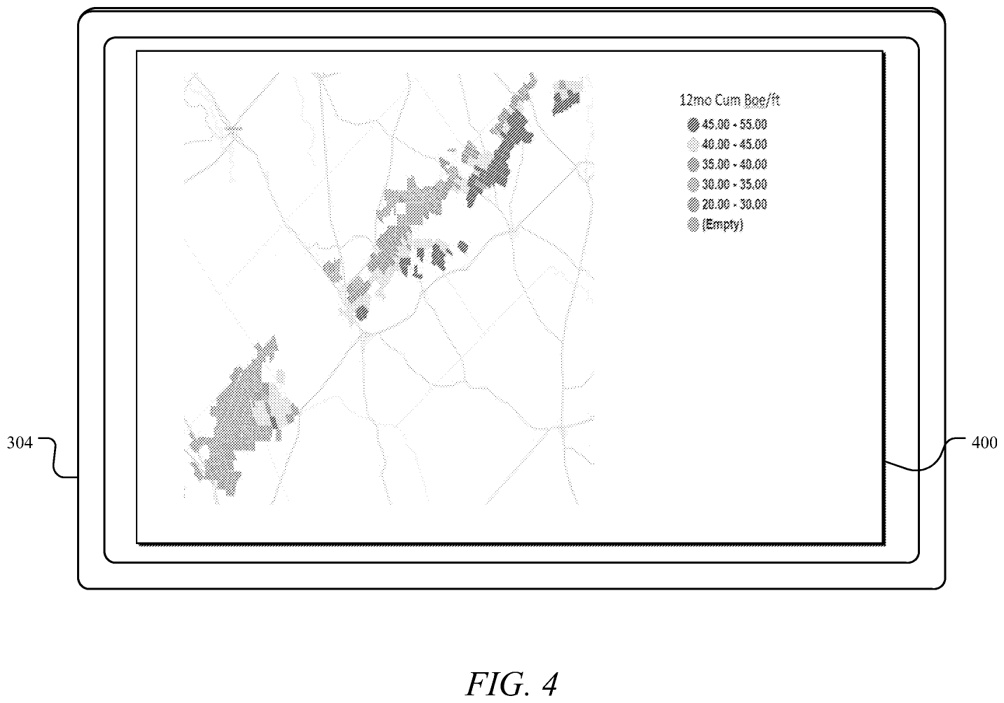

FIG. 4 depicts an example application of a model for a particular reservoir to predict budget at completion performance across equalizing feature acreage. In one implementation, a user interface 400 generated by the development prediction system 102 is presented with a computing device, such as the user device 304. For example, the user interface 400 may be presented with a display or other presentation system.

In one implementation, reservoir physics, including simulation models, is captured. A range of geological properties, such as BAC porosity and BAC Sw, are captured. The development prediction system 102 generates a single well model with geology and a range of completions, among other intelligence. A wide range in production for a given BVH may be primarily driven by uncertainty in fracture geometry with a next phase including geomechanics. The training data 106 includes selected cases, including a cumulative probability distribution in the P10-P90 range for prediction ranges outside the dataset limits. The user interface 400 shows a prediction of BAC performance across acreage of a particular reservoir, with various colors depicting 12 months cum Boe/ft. In this example, the predictions are assuming 2800 lb/ft completion size.

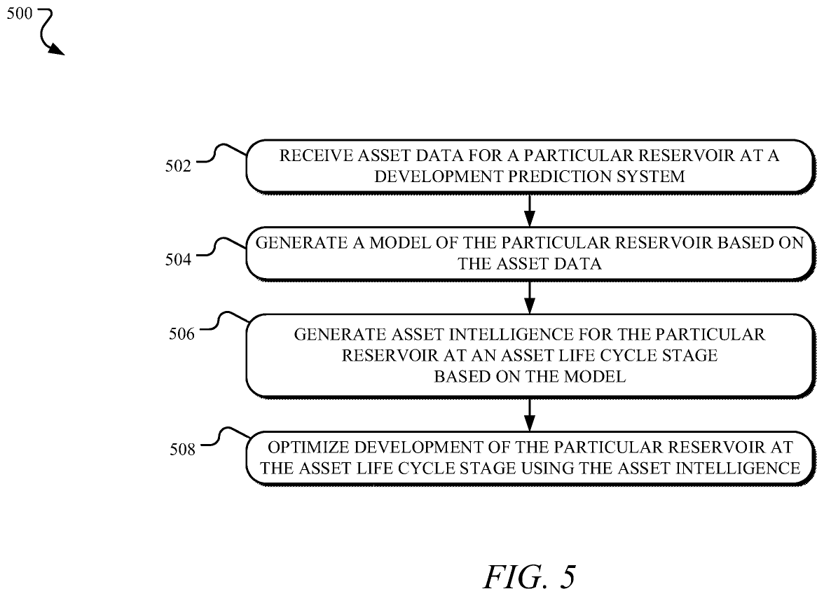

Turning to FIG. 5, example operations 500 for predictive reservoir development are shown. In one implementation, an operation 502 receives asset data for a particular reservoir at a development prediction system, and an operation 504 generates a model of the particular reservoir based on the asset data. An operation 506 generates asset intelligence for the particular reservoir at an asset life cycle stage based on the model. An operation 508 optimizes development of the particular reservoir at the asset life cycle stage using the asset intelligence.

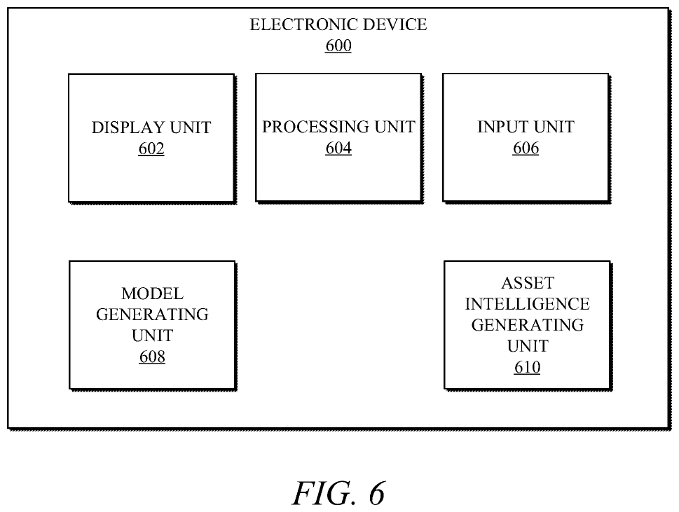

Turning to FIG. 6, an electronic device 600 including operational units 602-612 arranged to perform various operations of the presently disclosed technology is shown. The operational units 602-612 of the device 600 are implemented by hardware or a combination of hardware and software to carry out the principles of the present disclosure. It will be understood by persons of skill in the art that the operational units 602-612 described in FIG. 6 may be combined or separated into sub-blocks to implement the principles of the present disclosure. Therefore, the description herein supports any possible combination or separation or further definition of the operational units 602-612.

In one implementation, the electronic device 600 includes a display unit 602 configured to display information, such as a graphical user interface, and a processing unit 604 in communication with the display unit 602 and an input unit 606 configured to receive data from one or more input devices or systems. Various operations described herein may be implemented by the processing unit 604 using data received by the input unit 606 to output information for display using the display unit 602. Additionally, in one implementation, the electronic device 600 includes units implementing the operations described with respect to FIG. 5. For example, the operation 504 may be implemented by a model generating unit 608, and the operation 506 may be implemented by an asset intelligence generating unit 510.

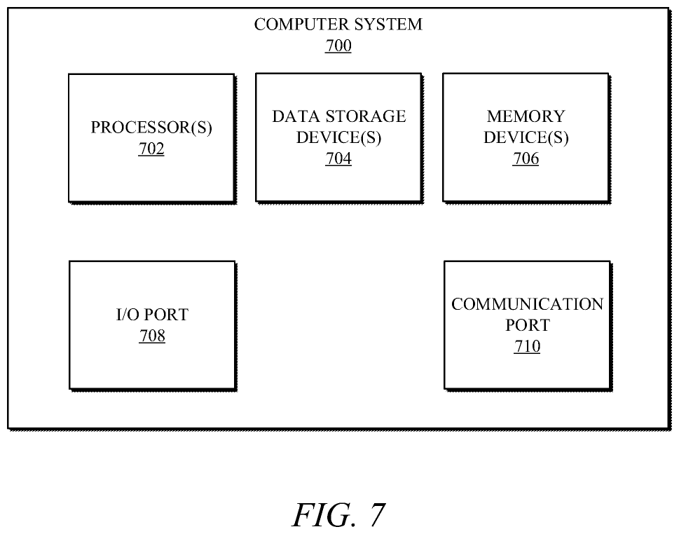

Referring to FIG. 7, a detailed description of an example computing system 700 having one or more computing units that may implement various systems and methods discussed herein is provided. The computing system 700 may be applicable to the development prediction system 102, the system 100, and other computing or network devices. It will be appreciated that specific implementations of these devices may be of differing possible specific computing architectures not all of which are specifically discussed herein but will be understood by those of ordinary skill in the art.

The computer system 700 may be a computing system is capable of executing a computer program product to execute a computer process. Data and program files may be input to the computer system 700, which reads the files and executes the programs therein. Some of the elements of the computer system 700 are shown in FIG. 7, including one or more hardware processors 702, one or more data storage devices 704, one or more memory devices 708, and/or one or more ports 708-710. Additionally, other elements that will be recognized by those skilled in the art may be included in the computing system 700 but are not explicitly depicted in FIG. 7 or discussed further herein. Various elements of the computer system 700 may communicate with one another by way of one or more communication buses, point-to-point communication paths, or other communication means not explicitly depicted in FIG. 7.

The processor 702 may include, for example, a central processing unit (CPU), a microprocessor, a microcontroller, a digital signal processor (DSP), and/or one or more internal levels of cache. There may be one or more processors 702, such that the processor 702 comprises a single central-processing unit, or a plurality of processing units capable of executing instructions and performing operations in parallel with each other, commonly referred to as a parallel processing environment.

The computer system 700 may be a conventional computer, a distributed computer, or any other type of computer, such as one or more external computers made available via a cloud computing architecture. The presently described technology is optionally implemented in software stored on the data stored device(s) 704, stored on the memory device(s) 706, and/or communicated via one or more of the ports 708-710, thereby transforming the computer system 700 in FIG. 7 to a special purpose machine for implementing the operations described herein. Examples of the computer system 700 include personal computers, terminals, workstations, mobile phones, tablets, laptops, personal computers, multimedia consoles, gaming consoles, set top boxes, and the like.

The one or more data storage devices 704 may include any non-volatile data storage device capable of storing data generated or employed within the computing system 700, such as computer executable instructions for performing a computer process, which may include instructions of both application programs and an operating system (OS) that manages the various components of the computing system 700. The data storage devices 704 may include, without limitation, magnetic disk drives, optical disk drives, solid state drives (SSDs), flash drives, and the like. The data storage devices 704 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 704 and/or the memory devices 706, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 700 includes one or more ports, such as an input/output (I/O) port 708 and a communication port 710, for communicating with other computing, network, or reservoir development devices. It will be appreciated that the ports 708-710 may be combined or separate and that more or fewer ports may be included in the computer system 700.

The I/O port 708 may be connected to an I/O device, or other device, by which information is input to or output from the computing system 700. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 700 via the I/O port 708. Similarly, the output devices may convert electrical signals received from computing system 700 via the I/O port 708 into signals that may be sensed as output by a human, such as sound, light, and/or touch. The input device may be an alphanumeric input device, including alphanumeric and other keys for communicating information and/or command selections to the processor 702 via the I/O port 708. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 700 via the I/O port 708. For example, an electrical signal generated within the computing system 700 may be converted to another type of signal, and/or vice-versa. In one implementation, the environment transducer devices sense characteristics or aspects of an environment local to or remote from the computing device 700, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 700, such as, physical movement of some object (e.g., a mechanical actuator), heating or cooling of a substance, adding a chemical substance, and/or the like.

In one implementation, a communication port 710 is connected to a network by way of which the computer system 700 may receive network data useful in executing the methods and systems set out herein as well as transmitting information and network configuration changes determined thereby. Stated differently, the communication port 710 connects the computer system 700 to one or more communication interface devices configured to transmit and/or receive information between the computing system 700 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 710 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G) network), or over another communication means. Further, the communication port 710 may communicate with an antenna or other link for electromagnetic signal transmission and/or reception.

In an example implementation, asset data, asset intelligence data, and software and other modules and services may be embodied by instructions stored on the data storage devices 704 and/or the memory devices 706 and executed by the processor 702. The computer system 700 may be integrated with or otherwise form part of the air filtration system 104.

The system set forth in FIG. 7 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for predictive reservoir development, the method comprising:
receiving asset data for a particular asset, the particular asset corresponding to a particular reservoir;
generating a model of the particular asset based on the asset data; and
generating asset intelligence for the particular asset at an asset life cycle stage based on the model, development of the particular reservoir being optimized using the asset intelligence.

2. The method of claim 1, wherein the asset intelligence is generated using a set of key variables, the set of key variables including a target variable and a plurality of dependent variables.

3. The method of claim 2, wherein the target variable is a 12-month cumulative in barrels of oil equivalent per foot.

4. The method of claim 2, wherein the plurality of dependent variables includes one or more of pressure (pr), estimated ultimate recovery (EUR) in millions of BOE, Young's modulus (YM), bulk volume hydrocarbon (BVH), Proppant per foot (prop/ft), spacing, and/or lateral length.

5. The method of claim 1, wherein the asset life cycle stage includes at least one of exploration and appraisal, development, production, or abandonment.

6. The method of claim 1, wherein the model includes a simulation of physics of the particular asset corresponding to the particular reservoir.

7. The method of claim 1, wherein the model is a single well model including a range of geological properties for the particular asset.

8. The method of claim 1, wherein the asset intelligence is generated based on a machine learning model trained using training data.

9. The method of claim 8, wherein the training data includes well data and mechanistic simulation cases representing assets at one or more stages of asset life cycle.

10. The method of claim 8, wherein the machine learning model includes at least one of random forest, linear regression, boosted trees, non-linear regression, support vector machine, or a neural network.

11. The method of claim 1, wherein the asset intelligence includes one or more of subsurface development strategy, land and unitization strategy, spacing and stacking pattern strategy, infrastructure and facilities strategy, completions strategy, production and operations strategy, and maintenance strategy.

12. The method of claim 1, wherein the asset life cycle stage is an early stage, a middle stage, or a late stage.

13. The method of claim 1, wherein the asset intelligence is used to optimize development strategy for undrilled parts of the particular reservoir.

14. One or more tangible non-transitory computer-readable storage media storing computer-executable instructions for performing a computer process on a computing system, the computer process comprising:
receiving asset data for a particular asset, the particular asset corresponding to a particular reservoir;
generating a model of the particular asset based on the asset data; and
generating asset intelligence for the particular asset at an asset life cycle stage based on the model, development of the particular reservoir being optimized using the asset intelligence.

15. The one or more tangible non-transitory computer-readable storage media of claim 14, wherein the asset intelligence is generated using a set of key variables, the set of key variables including a target variable and a plurality of dependent variables.

16. The one or more tangible non-transitory computer-readable storage media of claim 14, wherein the model includes a simulation of physics of the particular asset corresponding to the particular reservoir.

17. The one or more tangible non-transitory computer-readable storage media of claim 14, wherein the asset intelligence is used to optimize development strategy for undrilled parts of the particular reservoir.

18. The one or more tangible non-transitory computer-readable storage media of claim 14, wherein the asset intelligence is generated based on a machine learning model trained using training data.

19. The one or more tangible non-transitory computer-readable storage media of claim 18, wherein the training data includes well data and mechanistic simulation cases representing assets at one or more stages of asset life cycle.

20. A system for predictive reservoir development, the system comprising:
a development prediction system including a machine learning model trained using training data, the development prediction system generating asset intelligence for a particular asset at an asset life cycle stage based on a model of the particular asset generated with the machine learning model using asset data for the particular asset, development of the particular reservoir being optimized using the asset intelligence.
